(19) United States
(12) Patent Application Publication
(10) Pub. No.: US 2019/0057302 A1
(43) Pub. Date: Feb. 21, 2019

(54) MEMORY DEVICE INCLUDING NEURAL NETWORK PROCESSOR AND MEMORY SYSTEM INCLUDING THE MEMORY DEVICE

(71) Applicants: SK hynix Inc., Icheon (KR); Seoul National Unversity R&DB Foundation, Seoul (KR)

(72) Inventors: Seunghwan CHO, Seoul (KR); Sungjoo YOO, Seoul (KR); Youngjae JIN, Seoul (KR)

(21) Appl. No.: 16/026,575

(22) Filed: Jul. 3, 2018

(30) Foreign Application Priority Data
Aug. 16, 2017 (KR) 10-2017-0103575

(51) Int. Cl. G06N 3/063

(52) U.S. Cl. CPC G06N 3/063; G06N 3/04

(57) ABSTRACT

A memory device may include a memory cell circuit; a memory interface circuit configured to receive a read command and a write command from a host and to control the memory cell circuit according to the read command and the write command; and a neural network processor configured to receive a neural network processing command from the host, to perform a neural network processing operation according to the neural network processing command, and to control the memory cell circuit to read or write data while performing the neural network processing operation.

### CROSS-REFERENCE TO RELATED APPLICATION

The present application claims priority to Korean Patent Application No. 10-2017-0103575, filed on Aug. 16, 2017, which is incorporated herein by reference in its entirety.

### BACKGROUND

### 1. Field

Embodiments of the present disclosure relate to a memory device including a neural network processor, and a memory system including the memory device.

### 2. Description of the Related Art

Convolutional Neural Networks (CNNs) are widely used in artificial intelligence applications, such as in autonomous vehicles. CNNs can be used to perform inference operations, such as image recognition.

A convolutional neural network includes an input layer, an output layer, and one or more inner layers between the input layer and the output layer. Each of the input, output, and inner layers includes one or more neurons. Neurons contained in adjacent layers are connected to each other by synapses. For example, synapses point from neurons in a given layer to neurons in a next layer. Alternately or additionally, synapses point to neurons in a given layer from neurons in a preceding layer.

Each neuron has a value, and each synapse has a weight. The values of the neurons included in the input layer are set according to an input signal. For example, in an image recognition process, the input signal is an image to be recognized.

During an inference operation, the values of the neurons contained in each of the inner and output layers are set according to values of neurons contained in a preceding layer, and weights of the synapses connected with the neurons in the preceding layer.

The weights of the synapses are set prior to the inference operation in a training operation that is performed on the convolutional neural network.

For example, after the convolutional neural network has been trained, the convolutional neural network can be used to perform an inference operation, such as an operation for performing image recognition. In the image recognition operation, the values of a plurality of neurons included in the input layer are set according to an input image, values of the neurons in the inner layers are set based on the values of the neurons in the input layer and the weights of the synapses that interconnect the layers of the convolutional neural network, and values of the neurons in the output layer are set based on the values of the neurons in the inner layers. The values of the neurons in the output layer represent a result of the image recognition operation, and is output at the output layer by computing the values of the neurons in the inner layers.

The training operation of the convolutional neural network, as well as the inference operation of the convolutional neural network, each include many computation operations performed by a memory device and/or a processor. When a computation operation is performed, a number of memory access operations are performed. The memory access operations include storing data temporarily in the memory device, using the processor to read data that is temporarily stored in the memory device, or a combination thereof.

However, the overall operation performance of a device including the convolutional neural network can be problematically degraded due to the time delays used for data input/output operations between the processor and the memory device.

### SUMMARY

In an embodiment, a memory device may include a memory cell circuit; a memory interface circuit configured to receive a read command and a write command from a host and to control the memory cell circuit according to the read command and the write command; and a neural network processor configured to receive a neural network processing command from the host, to perform a neural network processing operation according to the neural network processing command, and to control the memory cell circuit to read or write data while performing the neural network processing operation.

In an embodiment, a memory system may include a host; and a memory device configured to perform a read operation according to a read command provided from the host, a write operation according to a write command provided from the host and a neural network processing operation according to a neural network processing command provided from the host, wherein the memory device includes a memory cell circuit; a memory interface circuit configured to control the memory cell circuit according to the read command and the write command; and a neural network processor configured to perform a neural network processing operation according to the neural network processing command, and to control the memory cell circuit to read or write data while performing the neural network processing operation.

### BRIEF DESCRIPTION OF THE DRAWINGS

FIG. 1 illustrates a block diagram of a memory system according to an embodiment of the present disclosure.

FIG. 2 illustrates a block diagram of a neural network processor according to an embodiment of the present disclosure.

FIG. 3 illustrates a block diagram of a processing element according to an embodiment of the present disclosure.

FIG. 4 illustrates a flow chart representing an operation to allocate a neural network processing region in a memory device according to an embodiment of the present disclosure.

FIG. 5 illustrates a flow chart representing an operation to deallocate a neural network processing region in a memory device according to an embodiment of the present disclosure.

FIGS. 6 to 8 illustrate memory systems according to various embodiments of the present disclosure.

### DETAILED DESCRIPTION

Hereafter, various embodiments will be described below in more detail with reference to the accompanying drawings.

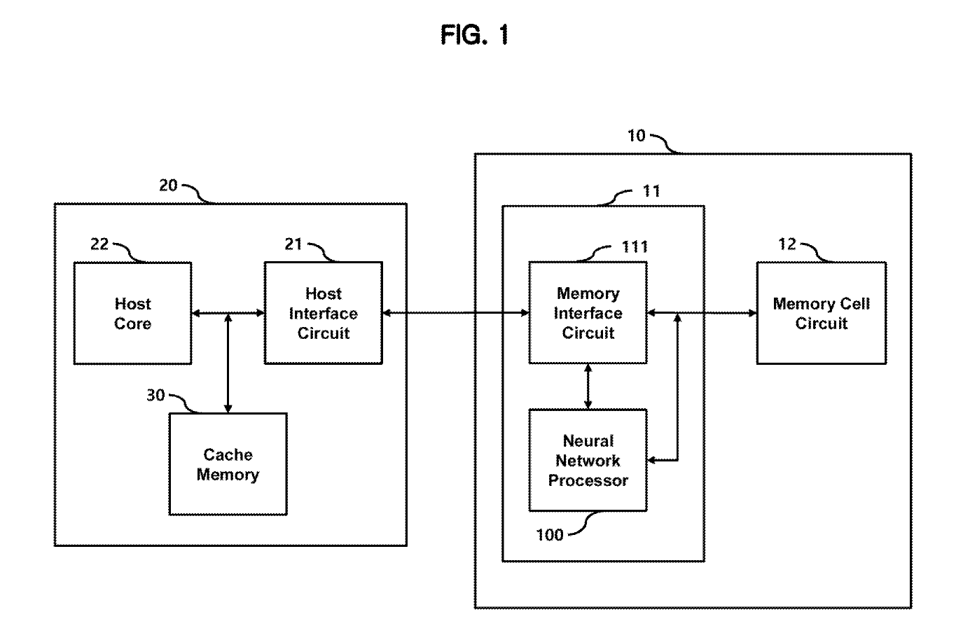

FIG. 1 illustrates a block diagram of a memory system according to an embodiment of the present disclosure. The memory system includes a memory device 10 and a host 20.

The memory device 10 includes a logic circuit 11 and a memory cell circuit 12. The logic circuit 11 and the memory cell circuit 12 may be a stacked structure. That is, the logic circuit 11 and the memory cell circuit 12 may be stacked together.

The memory cell circuit 12 may include any of various types of memory, such as a DRAM (Dynamic Random-Access Memory), an HBM (Hight Bandwidth Memory), a NAND flash memory, or the like. The memory cell circuit 12, however, is not limited to a specific type of memory.

The memory cell circuit 12 may be implemented by one or more types of memory technologies according to embodiments. An implementation of a memory interface circuit 111 may also be variously modified based on the implementation of the memory cell circuit 12.

The logic circuit 11 may include one or more logic dies, and the memory cell circuit 12 may include one or more cell dies.

The logic circuit 11 and the memory cell circuit 12 can transmit and receive data and control signals therebetween. In an embodiment, the data and control signals are transmitted and received through one or more TSVs (Thru Silicon Vias).

The logic circuit 11 includes the memory interface circuit 111 and a neural network processor 100. The memory interface circuit 111 and the neural network processor 100 may be disposed on the same logic die or on different logic dies.

The memory interface circuit 111 can control the memory cell circuit 12 and the neural network processor 100 according to a read command, a write command, and a neural network processing command, which are transmitted from the host 20. That is, the memory interface circuit 111 receives a read command, a write command, a neural network processing command, or a combination thereof, from the host 20. In an embodiment, the memory interface circuit 111 controls the memory cell circuit 12 to output data stored in the memory cell circuit 12 when the memory interface circuit 111 receives the read command from the host 20, controls the memory cell circuit 12 to store data when the memory interface circuit 111 receives the write command, controls the neural network processor 100 to perform a neural network processing operation when the memory interface circuit 111 receives the neural network processing command, or a combination thereof.

The memory cell circuit 12 can read and output data in accordance with a first control signal, write input data according to a second control signal, or both. Such control signals are output, for example, to the memory cell circuit 12 from the memory interface circuit 111.

The neural network processor 100 can start and end the neural network processing operation according to a control signal corresponding to the neural network processing command that is output from the memory interface circuit 111. For example, the neural network processor 100 starts the neural networking processing operation when the memory interface circuit 111 outputs a first neural network processing signal, ends the neural networking processing operation when the memory interface circuit 111 outputs a second neural network processing signal, or both.

In an embodiment, the neural networking processing operation is any of a training operation of a neural network and an inference operation of the neural network. The neural network is, for example, a convolutional neural network. Data structure for the neural network may be stored in the memory cell circuit 12.

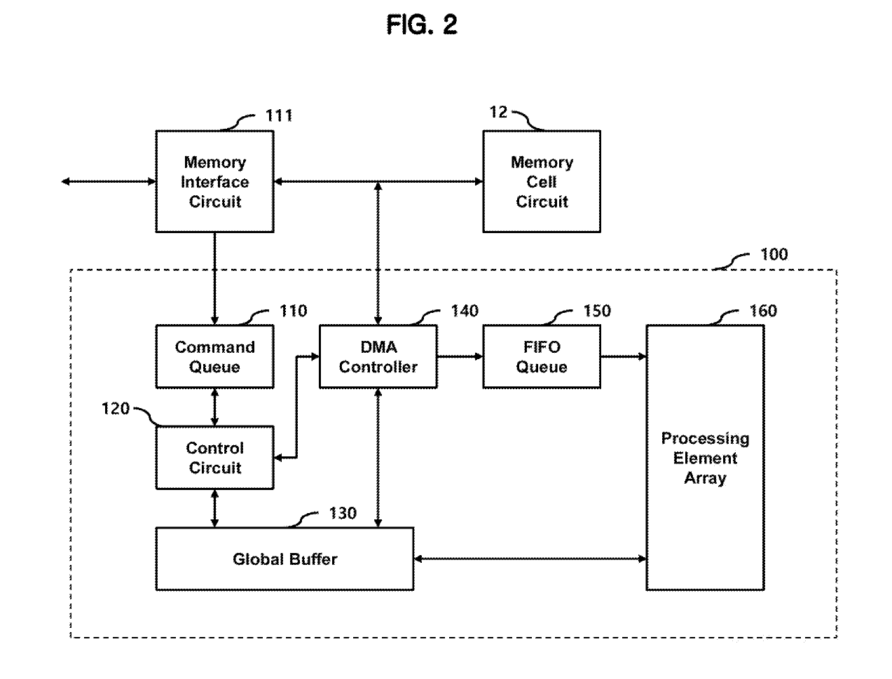

The neural network processor 100 can independently read or write data by controlling the memory cell circuit 12 while performing the neural network processing operation. For example, the neural network processor 100 can simultaneously control the memory cell circuit 12 to output data stored in the memory cell circuit 12 while controlling the neural network processor 100 to perform a training operation on the convolutional neural network. This will be described in detail with reference to FIG. 2.

The host 20 may correspond to a memory controller, a processor, or both. The host 20 is configured to control the memory device 10.

The host 20 includes a host interface circuit 21 and a host core 22. The host interface circuit 21 may receive read and write commands output from the host core 22, and may output the read and write commands to the memory device 10.

The host core 22 may provide a neural network processing command to the memory device 10. The neural network processing command is transmitted from the host core 22 to the neural network processor 100 through the host interface circuit 21 and the memory interface circuit 111.

The neural network processor 100 performs one or more neural network processing operations based on the neural network processing command.

The neural network processor 100 can independently control the memory cell circuit 12 while the neural network processor 100 is operating, as described above. For example, the memory interface circuit 111 can control the memory cell circuit 12 according to the read command and the write command output from the host 20 while the neural network processor 100 is performing a neural network processing operation.

The memory interface circuit 111 and the neural network processor 100 can control the memory cell circuit 12 simultaneously.

The memory cell circuit 12 can be controlled simultaneously by the memory interface circuit 111 and the neural network processor 100 because an address region of the memory cell circuit 12 is divided into a host region and a Neural Network Processor (NNP) region.

The division between the host region and the NNP region may be permanently fixed. In an embodiment, the division between the host region and the NNP region is temporarily sustained when the neural network processing operation is being performed.

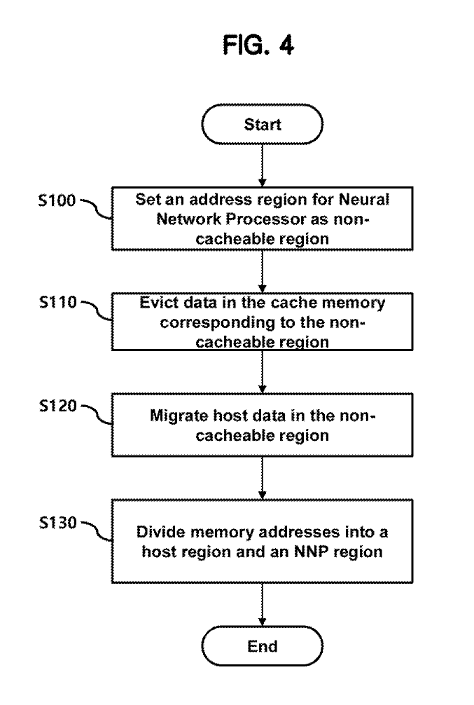

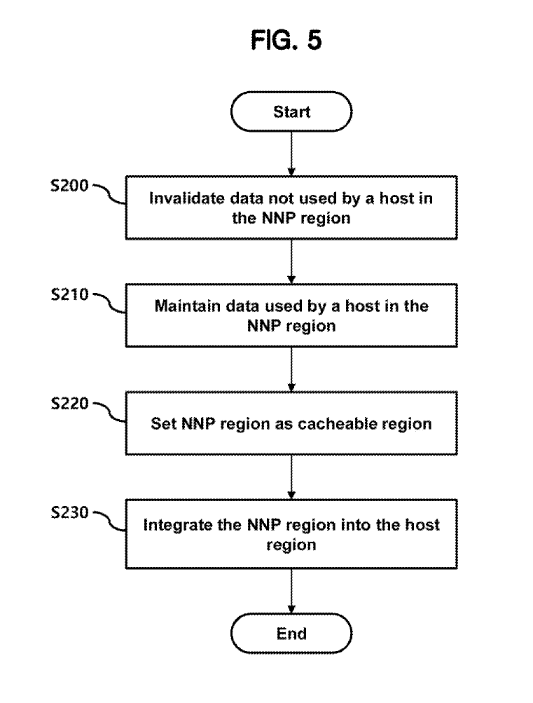

A process for allocating the NNP region and the host region into distinguished areas of the memory cell circuit 12 and a process for releasing the NNP region will be described in detail with reference to FIGS. 4 and 5.

The memory system may further include a cache memory 30. The cache memory 30 is a high-speed memory for storing a part of the data stored in the memory device 10.

In this embodiment, the cache memory 30 is located within the host 20. Specifically, the cache memory 300 is located between the host interface circuit 21 and the host core 22. The cache memory 30 may be located in other positions according to various embodiments.

Since cache memories, and processes for controlling cache memories, are well known to those having ordinary skill in the art, a detailed description of the cache memory 30 will be omitted.

In the present disclosure, the cache memory 30 may not store the data stored in the NNP region. This will be further described in detail below.

FIG. 2 illustrates a block diagram of the neural network processor 100 of FIG. 1 according to an embodiment of the present disclosure.

The neural network processor 100 includes a command queue 110, a control circuit 120, a global buffer 130, a direct memory access (DMA) controller 140, a first in first out (FIFO) queue 150, and a processing element array 160.

The command queue 110 stores neural network processing commands provided from the host 10.

The neural network processing commands may be sent to the command queue 110 via the memory interface circuit 111.

The control circuit 120 performs a neural network processing operation by controlling the neural network processor 100 according to a neural network processing command output from the command queue 110. In an embodiment, the control circuit 120 performs the neural network processing operation by controlling the entire neural network processor 100. The neural network processing operation may include, for example, a training operation of a neural network, an inference operation, or both. In an embodiment, the neural network is a Convolutional Neural Network (CNN), a Recurrent Neural Network (RNN), a Reinforcement Learning (RL) or an Autoencoder (AE).

The control circuit 120 controls the DMA controller 140 to read data related to the neural network processing operation, the data being stored in the memory cell circuit 12. The control circuit 120 further controls the DMA controller 140 to store the data related to the neural networking processing operation in the global buffer 130.

The data related to the neural network processing operation includes, for example, a weight of a synapse in the neural network.

The global buffer 130 may include a Static Random-Access Memory (SRAM). The global buffer 130 may temporarily store the data related to the neural network processing operation. The global buffer 130 may also temporarily store data output from the neural network as a result of the neural network processing operation. For example, the global buffer 130 stores values of one or more neurons in an output layer of the neural network.

The DMA controller 140 can access the memory cell circuit 12 directly without going through the memory interface circuit 111. The DMA controller 140 controls read and write operations of the memory cell circuit 12 by accessing the memory cell circuit 12.

The DMA controller 140 may provide data read out of the memory cell circuit 12 directly to the FIFO queue 150 without going through the global buffer 130.

The processing element array 160 includes a plurality of processing elements arranged in an array form. The processing element array 160 can perform various operations, such as convolution operations.

Data to be computed in the processing element array 160, temporal data used during the computation by the processing element array 160, or both, may be stored in the global buffer 130, the FIFO queue 150, or both.

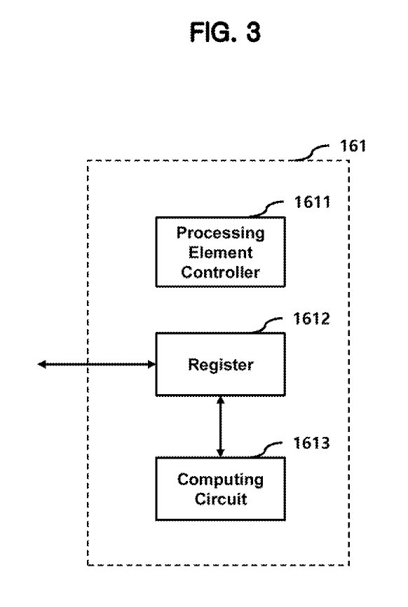

FIG. 3 illustrates a block diagram of a processing element 161 according to an embodiment of the present disclosure. The processing element 161 may be included in the processing element array 160 of FIG. 2.

The processing element 161 includes a processing element controller 1611, a register 1612, and a computing circuit 1613.

The processing element controller 1611 controls an arithmetic operation performed in the computing circuit 1613 and controls data input/output operations performed at the register 1612.

The register 1612 may temporarily store data to be computed by the computing circuit 1613, and may temporarily store data resulting from the computation by the computing circuit 1613. The register 1612 may be implemented using an SRAM.

The computation result stored in the register 1612 may be stored in the global buffer 130, and can be stored in the memory cell circuit 12 via the DMA controller 140.

The computing circuit 1613 performs various arithmetic operations. For example, the operation circuit 1613 can perform operations such as addition operations, multiplication operations, accumulation operations, etc.

In an embodiment, the host 20 can exclusively use the memory cell circuit 12 through the memory interface circuit 111 when the neural network processing operation is not in progress.

In an embodiment, the host 20 and the neural network processor 100 can use the memory cell circuit 12, simultaneously, when the neural network processing operation is in progress. To this end, the memory cell circuit 12 includes a host region and an NNP region. The host region is used by the host 20, and the NNP region is used by the neural network processor 100, when the host 20 and the neural network processor 100 use the memory cell circuit 12 at the same time.

The host region and the NNP region in the memory cell circuit 12 may be fixed in an embodiment.

In another embodiment, the NNP region may not be fixed, and may be dynamically allocated. Specifically, a first switching operation for allocating a part of the host region that is the NNP region, and a second switching operation for releasing the NNP region and reallocating the released region to the host region, may be performed according to whether the neural network processing operation is completed or not.

The first and second switching operations can be performed by the host 20, which controls the memory cell circuit 12 through the memory interface circuit 111.

One or more commands for commanding the host 20 to perform the first and second switching operations may be predefined.

For example, a user may implement operations to perform a neural network processing operation on the memory device 10 in source code, and a compiler may compile the source code to generate the predefined command.

The host 20 can perform the first switching operation, the second switching operation, or both, by providing the predefined command to the memory cell circuit 12 through the memory interface circuit 111.

For example, when the host 20 outputs a neural network processing command to the neural network processor 100 via the memory interface circuit 111, the first switching operation can be performed together with the neural network processing operation, in advance of the neural network processing operation, or both.

In addition, the neural network processor 100 can inform the host 20 when the neural network processing operation is completed.

At this time, the neural network processor 100 may provide the host 20 with an address in the NNP region of the memory cell circuit 12 where a result of the neural network processing operation is stored.

Then, the host 20 can perform the second switching operation.

FIG. 4 illustrates a flow chart representing an operation to allocate a neural network processing region in a memory device according to an embodiment of the present disclosure.

First, the host 20 sets an address region used by the neural network processor 100 as a non-cacheable region at S100.

At S110, the host 20 evicts data stored in the cache memory 30 corresponding to the non-cacheable region.

At S120, the host 20 migrates a portion of the data evicted from the non-cacheable region, which is to be used by the neural network processor 100.

To do this, the host 20 may change the mapping relationship between a logical address and a physical address for the data to be migrated.

The address mapping information may be stored in the host 20.

The host 20 may use the address mapping information to control the memory cell circuit 12 to move the data stored in the existing physical address to the new physical address.

Finally, the host 20 may divide the memory device 10 into a host region and an NNP region at S130.

Information about the NNP region may be provided to the neural network processor 100.

The two regions have mutually exclusive address spaces. According to an embodiment, the host region is accessible only by the host 20, and the NNP region is accessible only by the neural network processor 100.

Accordingly, in the present disclosure, the host 20 can access the host region even during the operation of the neural network processor 100, thereby preventing performance degradation of the memory device 10.

However, if the memory interface circuit 111 and the neural network processor 100 share a bus between the memory cell circuit 12, one of them may wait to perform an operation after an operation performed by the other, in order to prevent data collision. For example, the memory interface circuit 111 performs an operation after the neural network processor 100 performs an operation. The performance of the memory device 10 is still improved in this embodiment relative to a memory device including a neural network processor that is located outside of the memory device 10.

If the NNP region is fixed to a specific address space, the performance of the memory device 10 can be improved by including separate buses for the host region and for the NNP region.

FIG. 5 illustrates a flow chart representing an operation to release an NNP region in a memory device according to an embodiment of the present disclosure.

First, among data stored in the NNP region of the memory device 10, data not used by the host 20 is invalidated at S200, and data to be used by the host 20 is maintained at S210. That is, data that is not used in an operation performed by the host 20 is deleted from the NNP region, and data that is used in the operation performed by the host 20 remains stored in the NNP region.

Addresses of the data to be used by the host 20 can be transferred from the neural network processor 100 to the host 20 when a neural network processing operation is completed.

In another embodiment, the data to be used by the host 20 may be stored in advance of the neural network processing operation in a predetermined address space.

For example, an inference result, that is, a result of a neural network performing an inference operation, can be used by the host 20. The host 20 can specify in advance an address at which the neural network processing command is to be executed.

In this case, the data in the memory device 10 other than the data of the address can be invalidated.

The host 20 sets a cacheable region for the NNP region at S220.

Then, the NNP region is integrated into the host region at S230.

The host 20 can read the result of the neural network processing operation by performing a general memory access operation.

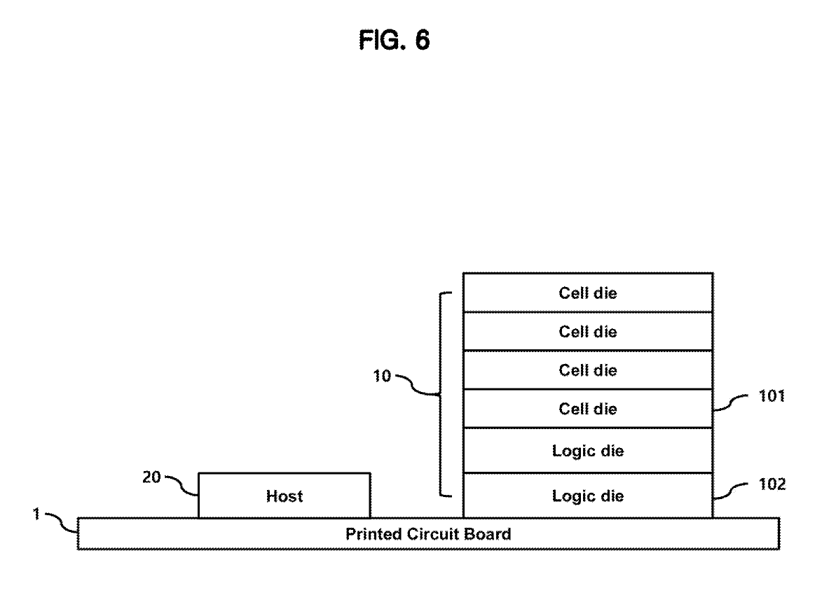

FIGS. 6 to 8 illustrate memory systems according to various embodiments of the present disclosure.

In the embodiment of FIG. 6, the memory system has a structure in which a host 20 and a memory device 10 are mounted on a printed circuit board 1. The host 20 and the memory device 10 transmit and receive signals through wiring of the printed circuit board 1.

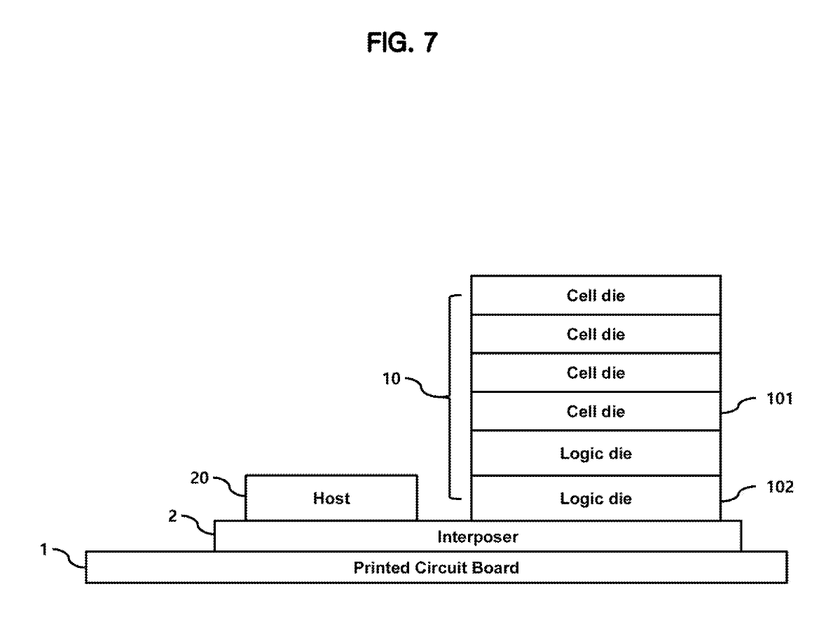

Alternatively, in the embodiment of FIG. 7, the memory system is configured such that the host 20 and the memory device 10 are disposed on an interposer 2, and the interposer 2 is disposed on the printed circuit board 1. That is, the interposer 2 is disposed between the printed circuit board 1 and the host 20, as well as between the printed circuit board 1 and the memory device 10.

In this case, the host 20 and the memory device 10 transmit and receive signals through wiring disposed in the interposer 2.

The host 20 and the memory device 10 can be packaged into a single chip.

In FIGS. 6 and 7, a memory cell circuit 12 includes a four-layer cell die 101, and a logic circuit 11 includes a two-layer logic die 102.

In this case, a memory interface circuit 111 and a neural network processor 100 may be disposed on different logic dies, respectively.

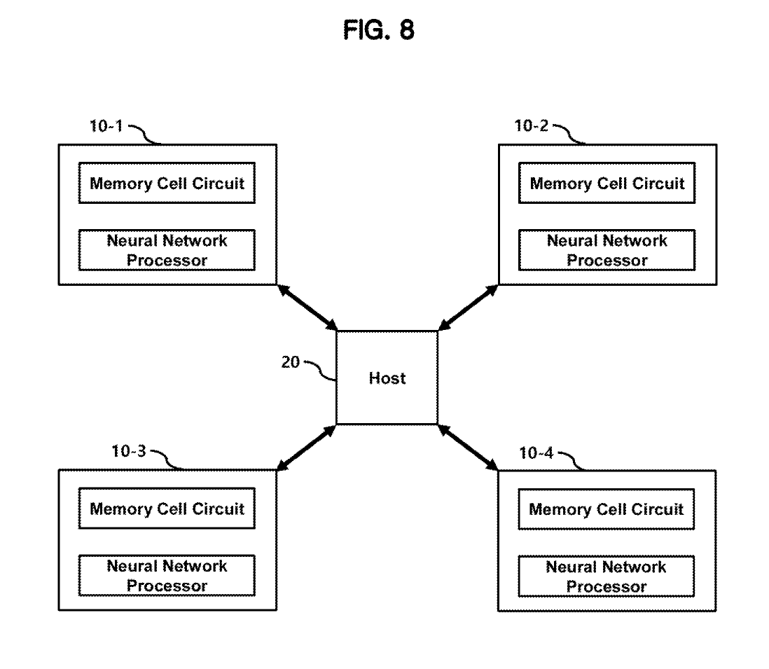

In the embodiment of FIG. 8, the memory system includes a plurality of memory devices 10-1, 10-2, 10-3, and 10-4 and a host 20. The host 20 is connected to each of the plurality of memory devices 10-1, 10-2, 10-3, and 10-4.

Each of the plurality of memory devices 10-1, 10-2, 10-3, and 10-4 may have the same configuration as the memory device 10 described above with reference to FIG. 1.

The host 20 may be a CPU or a GPU.

In the embodiment of FIG. 8, the plurality of memory devices 10-1, 10-2, 10-3, and 10-4 and the host 20 may be implemented in separate chips that are arranged on one printed circuit board, as shown in FIG. 6, or implemented in a single chip arranged on one interposer, as shown in FIG. 7.

In an embodiment, the host 20 may assign a separate neural network processing operation to each of the plurality of memory devices 10-1, 10-2, 10-3, and 10-4.

In another embodiment, the host 20 may divide one neural network processing operation into a plurality of sub-operations, and allocate the sub-operations to the plurality of memory devices 10-1, 10-2, 10-3, and 10-4, respectively. The host 20 may further derive a final result of the neural network processing operation by receiving output results from each of the memory devices 10-1, 10-2, 10-3, and 10-4.

When a plurality of neural network processing operations are performed using the same neural network, the plurality of memory devices 10-1, 10-2, 10-3, and 10-4 may be configured as pipelines, and may perform the plurality of neural network processing operations with improved throughput.

According to an embodiment of the present disclosure, a memory device includes a neural network processor provided in conjunction with a neural network. Accordingly, the memory device may perform faster operations. For example, times required for accessing the memory device, while the memory device is performing a training operation of the neural network and an inference operation using the neural network, are reduced, thereby improving the performance of a neural network processing operation.

In the present disclosure, an external host and an internal neural network processor can access a memory cell circuit at the same time by dividing an address region of the memory cell circuit into a host region and an NNP region, thereby preventing performance degradation caused by occupation of the memory cell circuit by the neural network processor.

Although various embodiments have been described for illustrative purposes, it will be apparent to those skilled in the art that various changes and modifications may be possible.

What is claimed is:

1. A memory device, comprising:
a memory cell circuit;
a memory interface circuit configured to receive a read command and a write command from a host, and to control the memory cell circuit according to the read command and the write command; and
a neural network processor configured to receive a neural network processing command from the host, to perform a neural network processing operation according to the neural network processing command, and to control the memory circuit to read or write data while performing the neural network processing operation.

2. The memory device of claim 1, wherein the memory cell circuit, the memory interface circuit, and the neural network processor comprise a stacked structure.

3. The memory device of claim 2, wherein the stacked structure includes a plurality of cell dies and one or more logic dies,
wherein the memory cell circuit is disposed in the plurality of cell dies, and
wherein the memory interface circuit and the neural network processor are disposed in the one or more logic dies.

4. The memory device of claim 3, wherein the memory interface circuit and the neural network processor are disposed in the same logic die.

5. The memory device of claim 3, wherein the memory interface circuit and the neural network processor are disposed in different logic dies.

6. The memory device of claim 1, wherein the neural network processor comprises:
a command queue configured to receive the neural network processing command provided by the memory interface circuit, and to store the neural network processing command;
a control circuit configured to control the neural network processing operation according to the neural network processing command stored in the command queue;
a global buffer, the control circuit controlling the global buffer to temporarily store first data;
a direct memory access (DMA) controller, the control circuit controlling the DMA controller to control second data input to the memory cell circuit, third data output from the memory cell circuit, or both; and
a processing element array configured to process an arithmetic operation using the first data from the global buffer, the second data from the DMA controller, the third data from the DMA controller, or a combination thereof.

7. The memory device of claim 6, wherein the neural network processor further comprises a first in first out (FIFO) queue configured to temporarily store fourth data output from the DMA controller, and to provide the fourth data to the processing element array, the fourth data including the second data, the third data, or both.

8. The memory device of claim 6, wherein the processing element array includes a plurality of processing elements, each comprising:
a register storing fifth data;
a computing circuit configured to generate an operation result by performing an arithmetic operation on the fifth data stored in the register and to store the operation result in the register; and
a processing element controller configured to control the computing circuit.

9. The memory device of claim 8, wherein the arithmetic operation includes one or more of an addition operation, a multiplication operation, and an accumulation operation.

10. The memory device of claim 1, wherein the memory cell circuit include a host region used by the host and a neural network processor (NNP) region used by the neural network processor when the neural network processor performs the neural network processing operation.

11. The memory device of claim 1, wherein the NNP region is allocated according to a command provided from the host before the neural network processing operation is performed.

12. The memory device of claim 11, wherein the NNP region is released according to a command provided from the host after the neural network processing operation is finished.

13. A memory system, comprising:
a host; and
a memory device configured to perform a read operation according to a read command provided from the host, to perform a write operation according to a write command provided from the host, and to perform a neural network processing operation according to a neural network processing command provided from the host,
wherein the memory device includes:
a memory cell circuit;
a memory interface circuit configured to control the memory cell circuit according to the read command and the write command; and
a neural network processor configured to perform the neural network processing operation according to the neural network processing command, and to control the memory cell circuit to read or write data while performing the neural network processing operation.

14. The memory system of claim 13, wherein the host and the memory device are packaged in a chip.

15. The memory system of claim 13, further comprising a cache memory configured to cache data stored in the memory device.

16. The memory system of claim 13, wherein the memory device allocates a neural network processor (NNP) region in the memory cell circuit, the NNP region being exclusively used by the neural network processor when the neural network processor receives the neural network processing command from the host.

17. The memory system of claim 16, wherein the memory device migrates data stored in the NNP region to a free space in a host region allocated in the memory cell circuit.

18. The memory system of claim 16, wherein the host performs a caching operation on data other than the data stored in the NNP region.

19. The memory system of claim 16, wherein the host controls the memory device to release the NNP region when the neural network processor notifies the host of the end of the neural network processing operation.

20. The memory system of claim 19, wherein the neural network processor provides a predetermined address to the host, the predetermined address indicating where a result of the neural network processing operation is stored, and
wherein data stored at the predetermined address remains stored at the predetermined address when the NNP region is released.

21. The memory system of claim 20, further comprising a plurality of memory devices, the host controlling each of the plurality of memory devices to perform a part of the neural network processing operation.
